(19) United States
(12) Patent Application Publication
(10) Pub. No.: US 2021/0337738 A1
(43) Pub. Date: Nov. 4, 2021

(54) Tying Device for an Agricultural Crop Press and Agricultural Crop Press with Such a Tying Device

(71) Applicant: Maschinenfabrik Bernard Krone GmbH & Co. KG, Spelle (DE)

(72) Inventor: Michael Meiners, Schapen (DE)

(21) Appl. No.: 17/242,385

(22) Filed: Apr. 28, 2021

(30) Foreign Application Priority Data
Apr. 29, 2020 (DE) 10 2020 002 578.1

(51) Int. Cl. A01F 15/14

(52) U.S. Cl. CPC A01F 15/145; A01F 15/148

(57) ABSTRACT

A tying device for an agricultural crop press has a drive unit for driving the tying device and a work unit for processing crop which is switchable from a coupled state, in which it is coupled to the drive unit and driven, into a decoupled state, in which it is not coupled to the drive unit and not driven. The work unit has a pawl and the drive unit has a coupling device with which the work unit and the drive unit are operatively connectable. The coupling device interacts in the coupled state of the work unit with the pawl. The drive unit has an electromagnetically acting switch that is switchable reversibly from an inactive into an active state and that is configured to trigger or to terminate the operative connection of the coupling device with the pawl. An agricultural crop press is provided with such a tying device.

### BACKGROUND OF THE INVENTION

The present invention concerns a tying device for an agricultural crop press, with a drive unit for driving the tying device and with a work unit that can be switched from a coupled state, in which it is coupled to the drive unit so that it is driven, into a decoupled state, in which it is not coupled to the drive unit so that it is not driven, wherein the work unit comprises a pawl and the drive unit comprises a coupling device with which the work unit and the drive unit are operatively connectable, and wherein the coupling device interacts with the pawl in the coupled state of the work unit. The present invention concerns moreover an agricultural crop press, in particular a square bale press, with such a tying device.

Crop bales that are pressed in bale presses are regularly tied with a tying material after completion so that they do not fall apart. For this purpose, for example, strip-shaped tying materials such as strips or twines are used. Such tying materials are provided in a tying device that comprises a top twine guide comprising a knotter as well as a bottom twine guide. After completion of the bale, the bottom twine guide is guided to the top twine guide, and a bottom twine is knotted with a top twine, respectively. As a measure for completion of the bale, typically the bale length is utilized. However, it is also known to trigger tying of the bale by time control.

Triggering of the knotting process is initiated hydraulically or electrically. Electrical solutions require however high current drains that test the limits of performance of the electrical onboard supply system of the agricultural crop press. Often, it is required for this purpose to not activate other consumers of the agricultural crop press at this point in time or to throttle them.

Mechanical systems provide no longer the desired comfort of today's crop presses and are in addition very wear-prone which has an effect on the precision of the bale length.

Often, a manually actuatable hand actuation for the knotting process is additionally required up to now for servicing and adjusting work.

Object of the invention is to avoid the aforementioned disadvantages and to create a tying device for an agricultural crop press which reliably performs inexpensively and with a precise, in particular pre-adjusted, bale length the knotting process automatically, without loading the electrical onboard supply system of the crop press and without increased component wear, and in which in addition a manually actuatable hand actuation for servicing and adjusting work is avoided.

### SUMMARY OF THE INVENTION

The object is solved with a tying device for an agricultural crop press, with a drive unit for driving the tying device and with a work unit which is switchable from a coupled state, in which it is coupled to the drive unit so that it is driven, into a decoupled state, in which it is not coupled to the drive unit so that it is not driven, wherein the work unit comprises a pawl and the drive unit comprises a coupling device with which the work unit and the drive unit are operatively connectable, and wherein the coupling device interacts with the pawl in the coupled state of the work unit, characterized in that the drive unit comprises an electromagnetically acting switching means that is switchable reversibly from an inactive state into an active state and that is configured to trigger or to terminate the operative connection of the coupling device with the pawl.

The object is solved with an agricultural crop press, in particular square bale press, with a tying device as disclosed.

Advantageous embodiments can be taken from the dependent claims.

For this purpose, a tying device for an agricultural crop press is provided. The tying device comprises a drive unit for driving the tying device. Moreover, it comprises a work unit which is switchable from a coupled state, in which it is coupled to the drive unit so that it is driven, into a decoupled state, in which it is not coupled to the drive unit so that it is not driven. In this context, the work unit comprises a pawl and the drive unit comprises a coupling device with which the work unit and the drive unit are operatively connectable. For this purpose, it is provided that the coupling device interacts with the pawl in the coupled state of the work unit.

The tying device is distinguished in that the drive unit comprises an electromagnetically acting switching means that is switchable reversibly from an inactive state into an active state and that is configured to trigger or to terminate the operative connection of the coupling device with the pawl.

The switching means enables an automatic execution of the tying process. Due to the electromagnetic actuation, it is done without friction and therefore without component wear. In addition, a manual hand actuation for servicing and adjusting work can be dispensed with for this tying device.

In this context, it is preferred that the electromagnetically acting switching means is not supplied with current in the inactive state and is supplied with current in the active state. Since the switching means is not supplied with current in the inactive state and is supplied with current only in the active state, the current consumption for the switching means is very minimal. Switching of the coupling process by means of which the knotting process is switched therefore does not lead to an overload of the electrical onboard supply system of the crop press. Throttling or temporarily avoiding actuation of other consumers can therefore be avoided by utilization of the electromagnetically acting switching means.

The switching means is preferably an electromagnetically actuated brake, preferably a spring force brake. For such a brake, a holding moment is applied against the force of a spring. Furthermore, the switching means can be designed also as an electromagnetically actuated coupling. The electromagnetically actuated brake or coupling requires only a minimal installation space, is wear-resistant, and can be switched in a very short switching time from the inactive state into the active state and/or back. Therefore, triggering or terminating of the coupling process can be performed very quickly and very precisely with respect to timing.

In this context, it is particularly preferred that the switching means exerts its holding moment in the state without supply of current. In this way, it must be supplied with current only in order to effect coupling and/or decoupling of the work unit to the drive unit. In a very particularly preferred embodiment, the switching means is only provided for triggering the operative connection of the coupling device with the pawl. In this embodiment, a mechanism utilized for triggering is held without supply of current, i.e., in the inactive state of the switching means, by the holding moment exerted by it.

Preferably, the switching means interacts with a switching lever, wherein it holds the switching lever in the inactive state by friction and/or form fit in a rest position and releases it in the inactive state so that the switching lever is adjustable from the rest position into a release position. In this context, it is preferred that the switching lever is adjustable by the force of a pretension element, preferably by the force of a spring, from the rest position into the release position. The release of the switching lever is thus possible with extremely minimal current consumption. For coupling and/or decoupling of the work unit, only very little current is required therefore in operation, and the operation of the agricultural crop press is thus possible in an inexpensive manner.

Restoring the switching lever from the release position into the rest position is furthermore realized in this context preferably by cam track control. In this context, the switching lever is adjusted against the force of the pretension element. The force of the pretension element for this is preferably smaller than a holding force of the switching means. This causes no further current consumption at all.

In order to ensure that the work unit in the rest position of the switching lever is not driven, the switching lever in its rest position holds the pawl preferably in a base position in which it is disengaged from the coupling device. In this embodiment, the work unit in the rest position of the pawl is not coupled to the drive unit and therefore is not driven. Furthermore, it is preferred that the switching lever in its release position releases the pawl so that the pawl is adjustable from the base position into a coupling position in which it is operatively connectable or operatively connected to the coupling device. The release of the switching lever, and therefore of the pawl, therefore triggers in this embodiment coupling of the work unit to the drive unit.

However, an embodiment is also preferred in which the pawl in the rest position of the switching lever is in engagement with the coupling device so that the work unit is driven. The pawl is then in the coupling position. In this context, it is preferred that the pawl in the release position of the pawl is disengaged from the coupling device so that the work unit is not driven. The pawl is then in the base position. In this way, the work unit is decoupled from the drive unit. It is then in the decoupled state and driving of the work unit is terminated.

The coupling device comprises for this purpose preferably a coupling bell that is rotatable about a coupling axis and in which a follower is arranged. In the coupling position of the pawl, the follower is moved preferably into contact at the pawl upon rotation of the coupling bell. The pawl is then driven by rotation of the coupling bell.

In order to drive the work unit, it is preferred that it comprises a crank that is arranged so as to be rotatable about the coupling axis of the coupling device wherein the pawl is fastened so as to be rotatable about a pawl axis at the crank. When the pawl is driven, the crank is therefore rotated about the coupling axis.

In a preferred embodiment, the work unit comprises in addition a rocker that is fastened pivotably to the crank. The rocker is pivotable back and forth by rotation of the crank about the coupling axis. In the embodiment as a bottom twine guide, it conveys in this context the bottom twine to the knotter so that in the knotter the formation of a knot together with the top twine is possible.

The work unit is preferably a bottom twine guide of the agricultural crop press. When driving the work unit, the latter is pivoted back and forth. Knotter needles that are fastened to the rocker are also pivoted as the rocker is moved back and forth. The bottom twine that is guided through the knotter needles can thus be guided in this way to a knotter associated therewith and to the top twine associated therewith so that it is knotted with the latter. The crop press in this embodiment is preferably a square bale press.

In this context, it is preferred that the tying device comprises a control unit that is configured to switch the switching means as a function of an operating value. Preferably, the operating value is a preset value or a measured value. Particularly preferred, a measured bale length is utilized as a measured value. It is however also preferred to utilize a preset time as an operating value or a preset bale length.

In an also preferred embodiment, the work unit is a net tying or strip tying unit. The crop press of this embodiment is preferably a round bale press. In this embodiment, the switching means is also used for triggering the tying action. In this context, it is further preferred to use a measured bale diameter as an operating value for switching of the switching means.

The object is also solved by an agricultural crop press, preferably by a square bale press, with such a tying device or, also preferred, with a round bale press with such a tying device.

In this context, it is preferred that a nominal value for the operating value, in particular the bale length or the bale diameter of the bale, is adjustable at an operating unit by an operator of the crop press. Preferably, the coupling process is then triggered upon reaching or surpassing the nominal value or in the next cycle. Provided the agricultural crop press is a towed crop press, such an operating unit for inputting the nominal value can also be arranged in a tractor to which the agricultural crop press is hitched. The nominal value is then adjustable at the operating unit of the tractor. In principle, also a preset, in particular crop-depending, value can be utilized as a nominal value.

### BRIEF DESCRIPTION OF THE DRAWINGS

In the following, the invention will be explained with the aid of Figures. The Figures are only exemplary and do not limit the general inventive concept.

FIG. 1 shows schematically an agricultural crop press with a tying device according to the invention.

FIG. 2a and FIG. 2c show schematically a tying device according to the invention for the agricultural crop press of FIG. 1 in different perspective views, and FIG. 2b and FIG. 2d show an enlarged detail of FIGS. 2a and 2c, respectively.

FIGS. 3a, 3b, 3c, 3d, 3e, 3f, 3g each show a side view of the enlarged details of FIGS. 2b and 2d.

### DESCRIPTION OF THE PREFERRED EMBODIMENTS

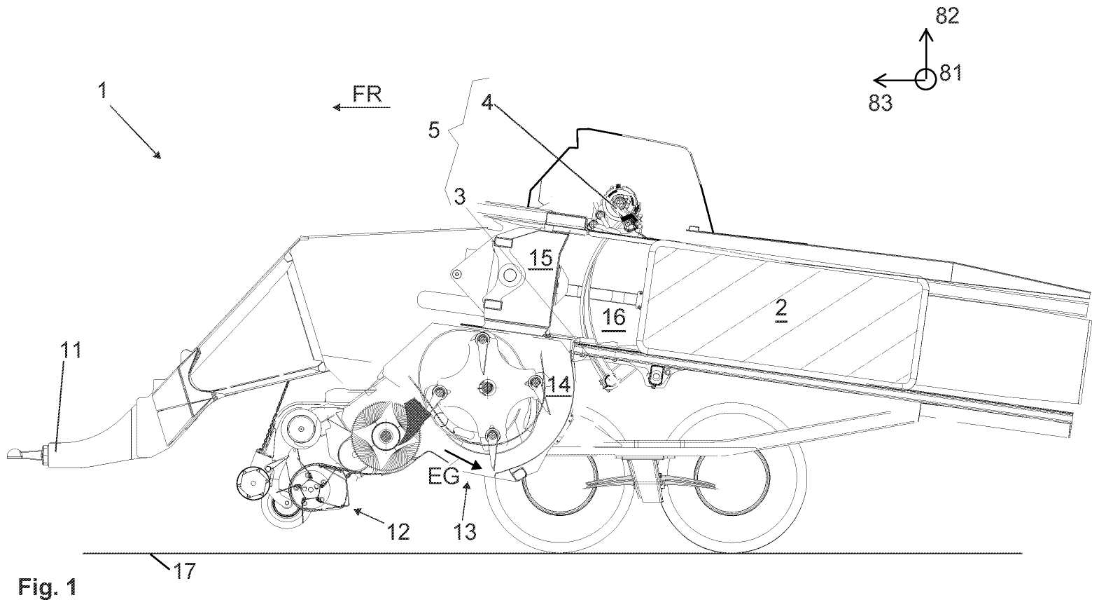

FIG. 1 shows schematically an agricultural crop press 1 with a tying device 5 according to the invention. The agricultural crop press 1 is a square bale press. In the following, the terms agricultural crop press 1 and square bale press are used synonymously.

The crop press 1 of FIG. 1 is provided for being pulled behind a tractor (not illustrated). It comprises for this purpose a trailer coupling 11 at the front in travel direction FR. The invention is however also suitable for self-propelled crop presses.

The crop press 1 comprises as a receiving device 12 a pick-up for picking up crop from the ground 17. The crop is supplied to a cutting device (not identified) which is arranged downstream of the receiving device 12 in a crop flow direction EG. After cutting, it is supplied to a conveying and collecting device 13 that is provided for collecting and pre-pressing the crop. The conveying and collecting device 13 comprises a collecting chamber 14 for this purpose. In the crop flow direction EG downstream thereof, a press channel 16 is provided. Upon sufficient free-compression of the crop in the collecting chamber 14, it is conveyed by means of a rake of the conveying and collecting device 13 embodied as a feed rake (not identified) from the collecting chamber 14 into the press channel 16. Here it is pressed by a press piston 15, which is moved back and forth in the press channel 16 in a cyclic manner, to a square bale 2.

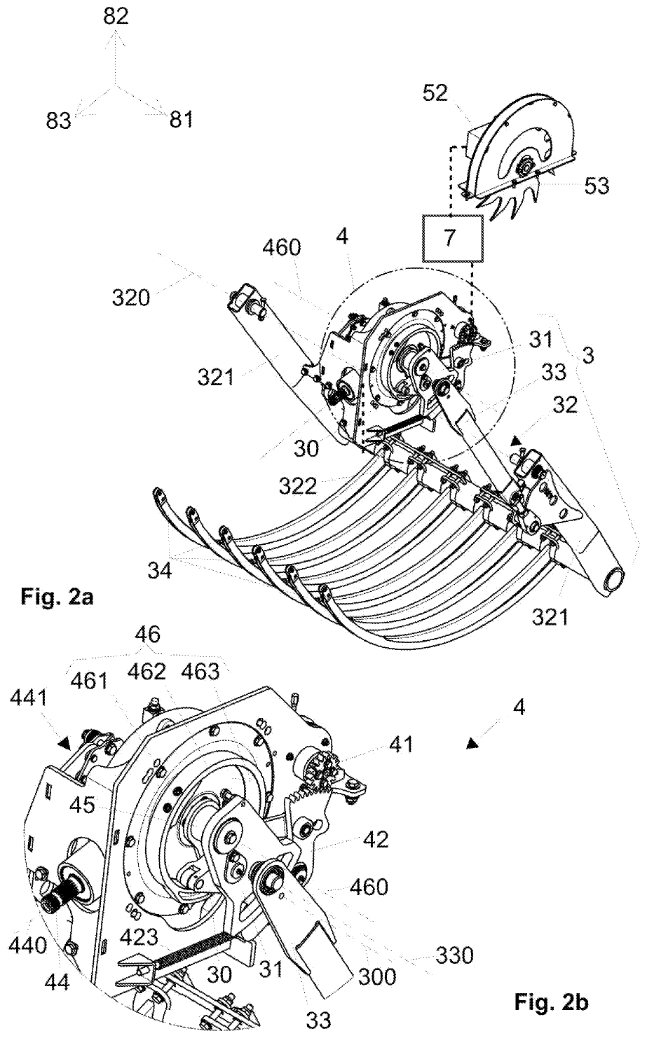

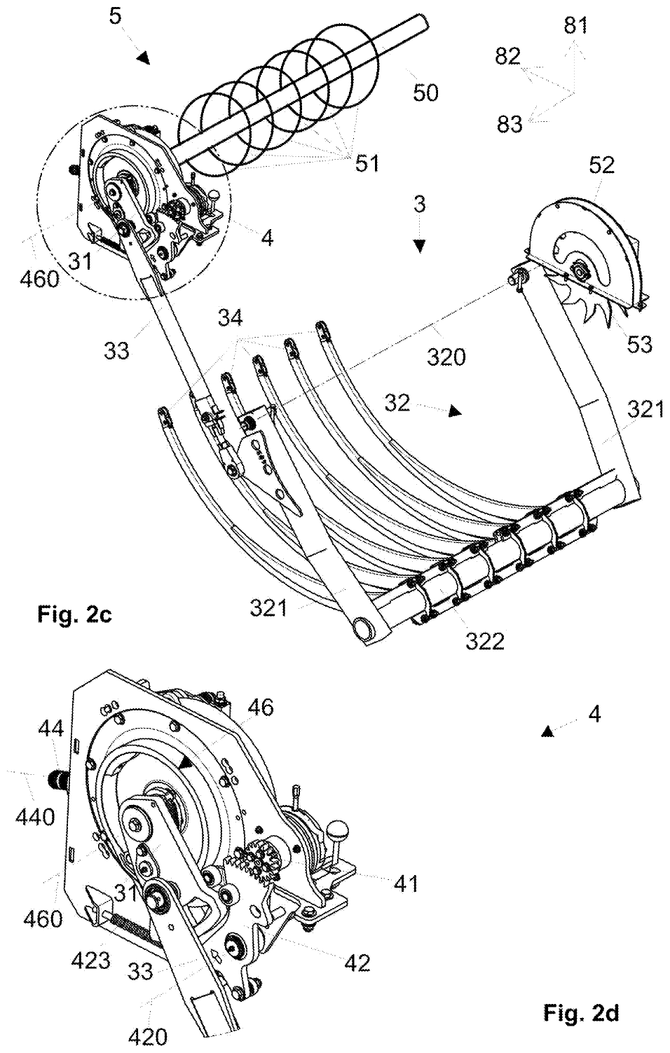

The square bale press 1 comprises a tying device 5 that is provided for tying the square bale 2 so that it does not fall apart. For this purpose, the tying device 5 comprises a plurality of knotters 51 (see FIG. 2c) which are provided for tying a knot. The knotters 51 each are provided to guide a top twine (not shown) of the tying material. They are arranged above the press channel 16. Moreover, the tying device 5 comprises a work unit 3 that is provided for guiding bottom twines (not shown) of the tying material. The work unit 3 will be referred to in the following also as bottom twine guide. The bottom twine guide 3 is arranged below the press channel 16. It comprises for each one of the knotters 51 a knotter needle 34 (see FIG. 2a) that respectively guide a bottom twine to the knotter 51 associated therewith for tying a knot. This can be realized only in a window of time in which the press piston 15, moved back and forth in the press channel 16 in a cyclic manner, releases the latter.

The bale 2 is tied when a nominal value for a bale length is reached or surpassed. Alternatively, the bale 2 can also be tied in the following cycle. The nominal value is adjustable by the operator at an operating unit (not illustrated). For measuring the bale length, the square bale press 1 comprises a length sensor 52 (see FIGS. 2a and 2c). The length sensor 52 comprises here a measuring wheel 53 that, upon displacement of the bale 2 in the press channel, engages 16 the bale 2, and then rotates. Based on the number of revolutions, the bale length is determined.

When the bale length is reached, the bottom twine guide 3 must be driven so that the knotter needles 34 each are guided to the knotter 51 associated therewith. For this purpose, the tying device 5 comprises a drive unit 4.

FIG. 2a and FIG. 2c show schematically the tying device 5 in different perspective views, respectively. The tying device 5 comprises the bottom twine guide 3, the drive unit 4, and a stationary knotter shaft 50 (see FIG. 2c). The plurality of knotters 51 is arranged at the knotter shaft 50 (see FIG. 2c). The bottom twine guide 3 comprises for each one of the knotters 51 a knotter needle 34 associated therewith. FIGS. 2b and 2c show respectively an enlarged detail of FIGS. 2a and 2d.

The bottom twine guide 3 comprises a rocker 32 with two rocker arms 321 that are supported to be pivotable about a pivot axis 320 at the frame components (not illustrated) of the crop press 1. At an end (not identified) facing away from the pivot axis 320, the rocker arms 321 are connected to each other by a needle shaft 322. The rocker arms 321 and the needle shaft 322 are therefore arranged relative to each other approximately in a U-shape. The knotter needles 34 are fixedly attached to the needle shaft 322. In this way, the knotter needles 34 are also pivoted upon pivoting the rocker 32 back and forth.

For driving the rocker 32, a coupling 33 is provided which at one end (not identified) is fastened at one of the rocker arms 321 and at an oppositely positioned end (not identified) is fastened to be rotatable about a coupling axis 330 (see FIG. 2b) at a crank 31. The crank 31 is supported to be rotatable about a coupling axis 460 of a coupling device 46 of a drive unit 4. The coupling device 46 is provided for coupling the bottom twine guide 3 to the drive unit 4. In a coupled state A of the bottom twine guide 3 at the coupling device 46, the crank 31 is rotated. When rotating the crank 31 about the coupling axis 460, the crank 31 entrains the coupling 33. In this way, the rocker 32 is pivoted back and forth.

The drive unit 4 comprises a drive 44 which extends in the direction of a drive axis 440. In operation of the crop press 1, it is driven by a power take-off shaft (not shown) of a transfer gearbox (not shown) of the crop press 1 so as to rotate about it. The drive 44 drives a gear 441 that is embodied here as a bevel gear. The gear 441 drives an output 45 (see FIG. 2b) that is transversely and spatially displaced in a radial direction in relation to the drive 44. At the output 45 the coupling device 46 is fixedly fastened. The output 45 is arranged so as to be rotatable about the coupling axis 460 so that the coupling device 46 upon driving of the output 45 rotates about the coupling axis 460. The coupling device 46 comprises a coupling bell 462 with a coupling window 463 and a follower 461 wherein the follower 461 projects into the coupling window 463. The coupling device 46 is provided to couple in a coupling process the bottom twine guide 3 to the drive unit 4 so that the bottom twine guide 3 is driven.

For triggering the coupling process, the drive unit 4 comprises a switching means 41. The switching means 41 is here an electromagnetically actuated brake. In the following, therefore the term switching means 41 and brake are used synonymously. In principle, a coupling can also be utilized however as a switching means 41.

The switching means 41 can be switched from an active state a, in which it is supplied with current, into an inactive state i, in which it is not supplied with current. The here utilized brake 41 exerts its holding moment in the inactive state i, not supplied with current. However, electromagnetically actuated switching means 41 can be used also which apply their holding moment in the active state a in which current is supplied.

The switching means 41 is provided for holding a switching lever 42 in the inactive state i, not supplied with current, in a rest position R. The switching lever 42 is supported so as to be rotatable about a switching axis 420 at a frame (not identified) of the drive unit 4. In its rest position R, it holds a pawl 30 of the work unit 3, which is supported so as to be rotatable about a pawl axis 300 at the crank 31 of the work unit 3, in a base position G. For this purpose, the switching lever 42 comprises a stop arm 422 and the pawl 30 a release arm 302 which are contacting each other in the rest position R of the switching lever 42 and base position G of the pawl 30. In this context, the switching means 41 holds the switching lever 42 in the rest position R against the force of a pretension element 423 and the pawl 30 in the base position G against the force of a force means 303.

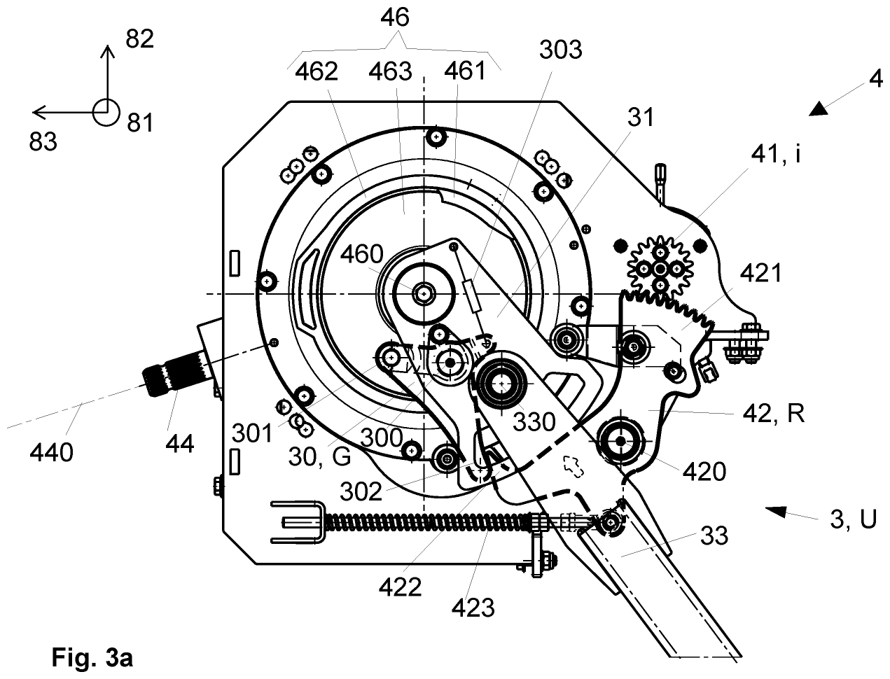

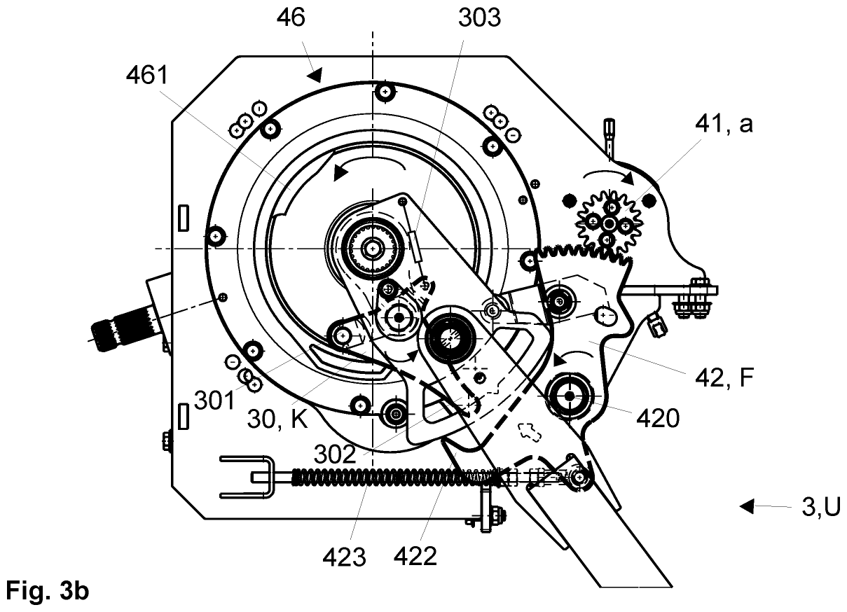

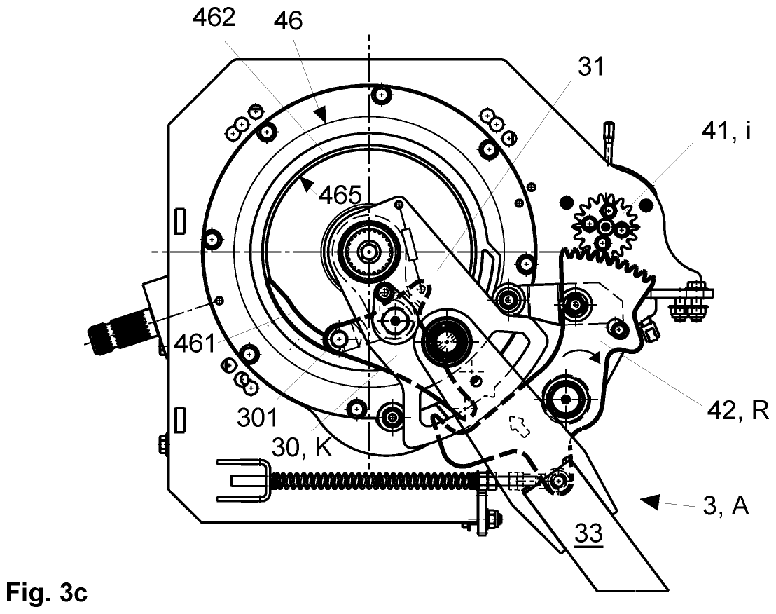

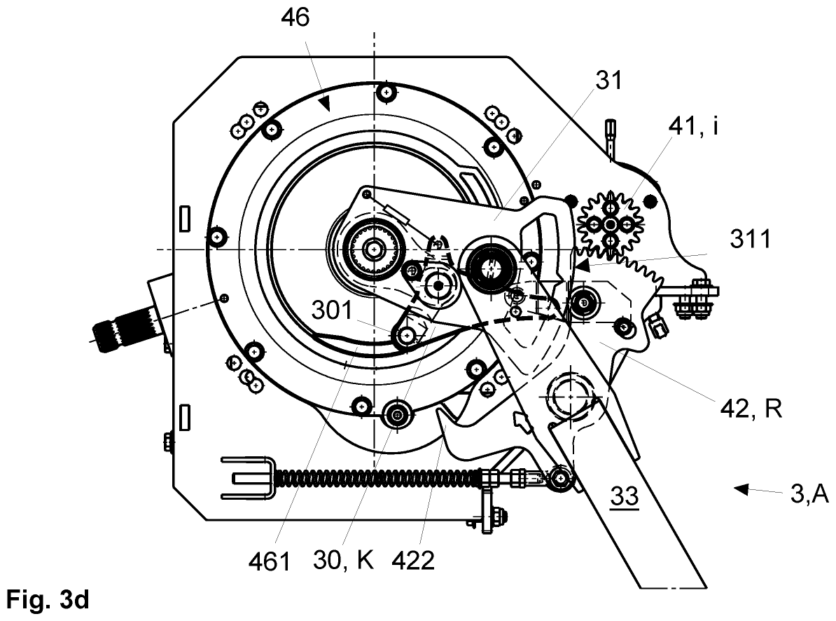

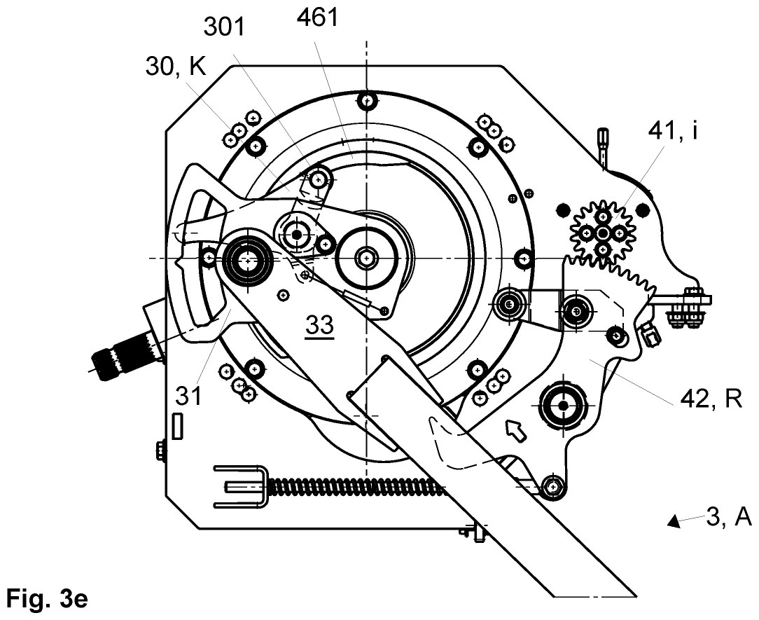

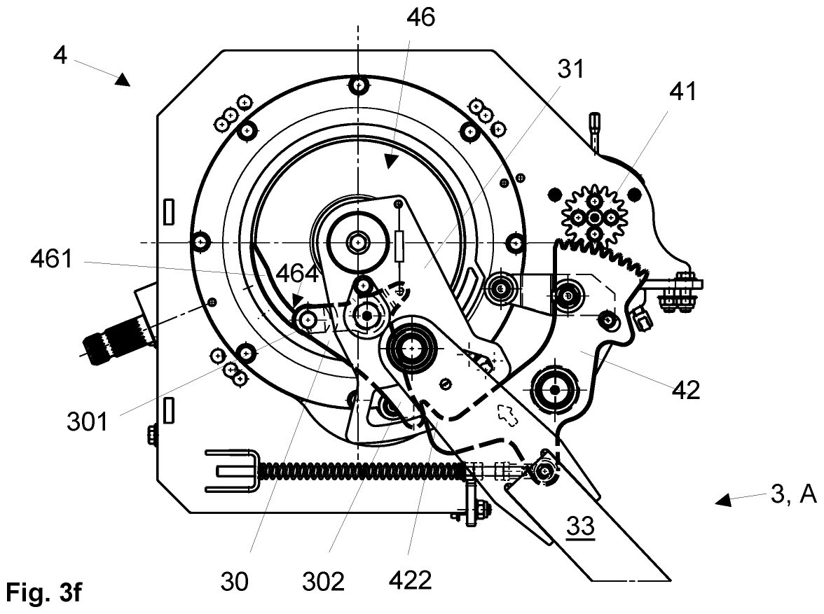

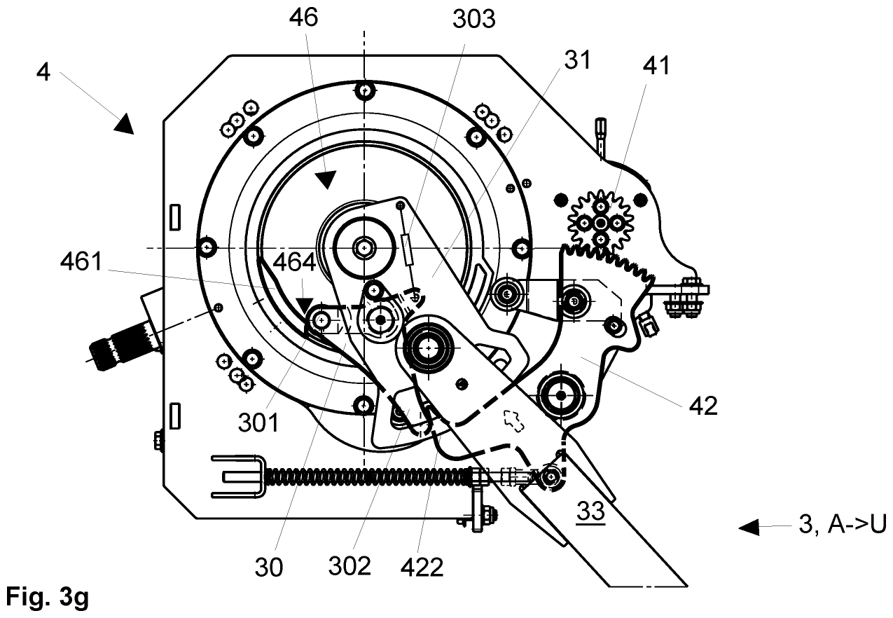

The pawl 30 comprises a switching arm 301 which projects into the coupling window 463. In the base position G of the pawl 30, the switching arm 301 is arranged to be out of engagement with the follower 461 during a revolution of the coupling bell 462. Therefore, the pawl 30 in the base position G is not driven so that the work unit 3 is not driven. The work unit 3 is then in a decoupled state U. The decoupled state U is shown in FIG. 3a.

By switching the switching means 41 from the inactive state i into the active state a, the holding moment drops. In this way, the switching lever 42 is rotatable about the switching axis 420 and is adjusted from the rest position R by the force of the pretension element 423 into a release position F. In this context, the stop arm 422 of the switching lever 42 releases the release arm 302 of the pawl 30. In this way, the pawl 30 rotates by the force of the force means 303 about the pawl axis 300 from the base position G into a coupling position K. This is shown in FIG. 3b.

In the coupling position K, the switching arm 301 is positioned in such a way in the coupling window 463 that the follower 461 during the revolution of the coupling bell 462 about the coupling axis 460 hits the switching arm 301. The pawl 30 is then operatively connected to the follower 461 of the coupling device 46 partially with form fit.

In the coupling position K of the pawl 30, the follower 461 therefore entrains the pawl 30 upon revolution of the coupling bell 462. In order to avoid wear, at the switching arm 301 of the pawl 30 a roller (not identified) is arranged that rolls upon revolution of the coupling bell 462 at an inner running surface 465 of the coupling bell 462. Since the pawl 30 is fastened at the crank 31 of the work unit 3, the crank 31, and together therewith the work unit 3, is driven in this context. The work unit 3 is then in the coupled state A. The coupled state A is illustrated in FIG. 3c.

The crank 31 comprises an outer contour 311 that upon rotation about the coupling axis 460 comes into contact at the switching lever 42. By means of the outer contour 311 of the crank 31, the switching lever 42, upon rotation from the release position F into the rest position R, is rotated back about the switching axis 420. In this context, the pretension element 423 is also restored. Moreover, the brake 41 is also restored in this context. Restoring of the brake 41 can be realized in the inactive state i of the brake 41, i.e, against its holding moment, as well as in the active state a of the brake 41. This is illustrated in FIG. 3d.

FIG. 3e shows the detail of the tying device 5 upon revolution of the crank 31 about the coupling axis 460 in the inactive state i of the brake 41 wherein the switching lever 42 is returned into the rest position R.

After a substantially complete revolution of the coupling bell 462, the release arm 302 of the pawl 30 hits the stop arm 422 of the switching lever 42. This is illustrated in FIG. 3f. The pawl 30 and the switching lever 42 are designed such that the holding moment of the brake 41 is not overcome in this context or even increases.

Upon further revolution of the coupling bell 462 about the coupling axis 460, the release arm 302 of the pawl 30 and the stop arm 422 of the switching lever 42 are contacting each other. The follower comprises a contour 464 that is designed such that the roller of the switching arm 301 of the pawl 30 rolls on the follower 461 so that the pawl 30 is rotated back about the pawl axis 300 from the coupling position K against the force of the force means 303 into the base position G. The work unit 3 is decoupled in this way from the coupling device 46. It is then again in the decoupled state U and is no longer driven. The transition from the coupled state A into the decoupled state U is shown in FIG. 3g.

As soon the nominal value of the bale length has been reached again or is surpassed, the sequence begins from the top.

What is claimed is:

1.-15. (canceled)

16. A tying device for an agricultural crop press, the tying device comprising:
a drive unit;
a work unit configured to be switched from a coupled state, in which the work unit is coupled to the drive unit to be driven by the drive unit, into a decoupled state, in which the work unit is not coupled to the drive unit and is not driven by the drive unit;
wherein the work unit comprises a pawl;
wherein the drive unit comprises a coupling device;
wherein the pawl and the coupling device are configured to operatively connect the work unit and the drive unit to each other, wherein the coupling device operatively interacts by an operative interaction with the pawl in the coupled state of the work unit;
wherein the drive unit further comprises an electromagnetically acting switching means configured to be switched reversibly from an inactive state into an active state, wherein the switching means is configured to trigger or to terminate the operative interaction of the coupling device with the pawl.

17. The tying device according to claim 16, further comprising a control unit configured to switch the electromagnetically acting switching means as a function of an operating value.

18. The tying device according to claim 17, wherein the operating value is a preset value or a measured value.

19. The tying device according to claim 18, wherein the preset value is a preset time and wherein the measured value is a bale length.

20. The tying device according to claim 16, wherein the electromagnetically acting switching means is an electromagnetically actuated brake or coupling.

21. The tying device according to claim 16, wherein the electromagnetically acting switching means is not supplied with current in the inactive state and is supplied with current in the active state.

22. The tying device according to claim 16, wherein the electromagnetically acting switching means is configured to interact with a switching lever, wherein the electromagnetically acting switching means, in the inactive state, holds the switching lever in a rest position with friction and/or form fit, and wherein the electromagnetically acting switching means, in the active state, releases the switching lever so that the switching lever is adjustable from the rest position into a release position.

23. The tying device according to claim 22, wherein the switching lever is adjustable by a force of a pretension element from the rest position into the release position.

24. The tying device according to claim 22, wherein the switching lever is configured to be restored from the release position into the rest position by a cam track control.

25. The tying device according to claim 24, wherein the switching lever is adjustable by a force of a pretension element from the rest position into the release position and is configured to be restored from the release position into the rest position by the cam track control against the force of the pretension element.

26. The tying device according to claim 22, wherein the switching lever, in the rest position, holds the pawl in a base position in which the pawl is disengaged from the coupling device.

27. The tying device according to claim 26, wherein the switching lever, in the release position, releases the pawl so that the pawl is adjustable from the base position into a coupling position in which the pawl is configured to operatively interact with the coupling device.

28. The tying device according to claim 27, wherein the coupling device comprises a coupling bell rotatable about a coupling axis and further comprises a follower arranged in the coupling bell, wherein the follower comes into contact with the pawl in the coupling position of the pawl when the coupling bell rotates.

29. The tying device according to claim 16, wherein the work unit comprises a crank arranged so as to be rotatable about a coupling axis of the coupling device, wherein the pawl is fastened at the crank so as to be rotatable about a pawl axis such that the crank rotates about the coupling axis when the pawl is driven.

30. The tying device according to claim 29, wherein the work unit comprises a rocker pivotably fastened at the crank so that the rocker is pivotable back and forth by a rotation of the crank about the coupling axis.

31. The tying device according to claim 16, wherein the work unit is a bottom twine guide.

32. An agricultural crop press with a tying device according to claim 16.

33. The agricultural crop press according to claim 32, wherein the agricultural crop press is a square bale press.
